(19) United States
(12) Patent Application Publication
(10) Pub. No.: US 2005/0135991 A1
(43) Pub. Date: Jun. 23, 2005

(54) Carbonaceous reductant for use in the fluidized bed chlorination of titanium-containing solids

(76) Inventors: Michael J. Engle, Chicago, IL (US); Robert E. Miller, Bowling Brook, IL (US)

Correspondence Address: Yale S. Finkle;UNOCAL, P.O. Box 7600, Brea, CA, 92822-7600, US

(21) Appl. No.: 10/740,973

(22) Filed: Dec. 19, 2003

(51) Int. Cl. C01G 23/02; B01J 21/18

(52) U.S. Cl. 423/492; 502/180; 502/182

(57) ABSTRACT

Carbon anode butts produced by the partial consumption of carbon anodes during the production of aluminum in electrolytic aluminum reduction cells are used, preferably in admixture with calcined petroleum coke, as the carbonaceous reductant in the fluidized bed chlorination of titanium-containing materials to make titanium tetrachloride.

### BACKGROUND OF INVENTION

This invention relates generally to the fluidized bed chlorination of titanium-containing solids and is particularly concerned with the carbonaceous reductant used in such a process.

Titanium dioxide (TiO₂) has various uses including pigments in paints, plastics and paper. Titanium dioxide is commonly produced by oxidizing titanium tetrachloride (TiCl₄), which can be made by chlorinating a titanium-containing material such as rutile or ilmenite ore. In one such chlorinating process, the titanium-containing raw material is reacted with chlorine in a fluidized bed reaction zone at a temperature usually between about 700° C. and 1100°0 C. in the presence of a particulate carbon reductant, usually calcined petroleum coke. The reaction occurs according to the following equation:
TiO₂+C+2Cl₂→TiCl₄+CO_{2.}

In order to maximize the efficiency of coke addition into the fluidized bed during the chlorinating process, the coke is usually sized to be a 60 by 4 mesh (U.S. Sieve Series) fraction that consists essentially of particles having a nominal size between about 250 and 5,000 microns. Particles smaller than about 250 microns are easily elutriated from the fluidized bed and lost from the process, while particles larger than 5,000 microns are not easily fluidized.

Unfortunately, a substantial quantity of the particulate coke used in the fluidized bed process becomes degraded into particles less than 250 microns by mechanical and/or chemical action during the chlorination process. These fine particulates are easily entrained in the fluidizing gases and carried overhead from the chlorination reactor. Thus, these particles have a relatively short residence time in the reaction zone and often exit the reactor in an unreacted state. These unreacted fines not only create a disposal problem, but also are a waste of the reductant value of the coke.

U.S. Pat. No. 5,389,353, the disclosure of which is hereby incorporated by reference in its entirety, proposes to avoid the above-discussed problems by using spherical particles of calcined petroleum shot coke or calcined petroleum fluid coke as the carbonaceous reductant instead of the calcined sponge coke that is typically used. The patent asserts that the use of such materials results in greater coke utilization, which in turns reduces coke costs and lessens disposal problems. However, depending on the type of crude from which it is produced, the fluid coke or shot coke may have high contents of sulfur and metals that preclude its use in the chlorination process. Thus, there is a need for an alternative source of the carbonaceous reductant that has lower concentrations of metals and sulfur than calcined petroleum fluid coke and calcined shot coke. In addition, there is a need for a carbonaceous reductant that possesses the characteristics, such as attrition resistance and density, that make it more desirable than calcined sponge coke for use as the carbon reductant in the chlorination of titanium-containing materials to produce titanium chloride.

### SUMMARY OF THE INVENTION

In accordance with the invention, it has now been found that anode butts produced by the partial consumption of carbon anodes during the production of aluminum in electrolytic aluminum reduction cells are ideal for use as at least a portion of the carbonaceous reductant in the fluidized bed chlorination of a titanium-containing material to produce titanium chloride. These anode butts are not only quite hard and dense, and therefore resistant to attrition and not easily elutriated from the fluidized bed, but also contain low amounts of sulfur, metals and ash because the anodes from which they are derived are made from very high quality petroleum coke in order to preclude contamination of the aluminum produced in the electrolytic cells. Furthermore, there is no need to calcine the butts prior to their use as the reductant because the anodes are baked when made and are exposed to high temperatures in the aluminum reduction cells.

Typically, the anode butts are crushed and mixed with sponge coke to form the carbon reductant. Since the mixture must be used in a fluidized bed, the particles of the mixture are sized such that they can be fluidized and are normally free of any substance that would tend to bind the particles together. Since the anode butts may contain residual amounts of aluminum, it is normally preferable that they compose, at the most, about 50 weight percent of the carbonaceous reductant.

### DETAILED DESCRIPTION OF THE INVENTION

Throughout the world much of the primary aluminum production is made in electrolytic reduction cells using pre-baked anodes. The anodes are produced by mixing quantities of a high quality petroleum coke with coal tar pitch and then baking the green anode to carbonize the pitch. The baked anode then becomes a carbon source or reductant in the cell, and is consumed in the reaction with alumina according to the following electrochemical reaction:
2Al₂O₃+3C→4Al+3CO₂

Properties of the petroleum coke used in the anode production are chosen based on cell operation and desired aluminum purity. Typical properties compared to other petroleum cokes are a low sulfur content to reduce sulfur oxide emissions and low ash and metals content. Ash and metals, such as nickel, iron and vanadium, can potentially become contaminants in the product aluminum. The low sulfur and metals content make such coke a relatively high quality material when compared to typical petroleum cokes which are produced as byproducts in the process of oil refining.

During operation of the aluminum cell, the anode is consumed. At a certain point based on the cell operation, it becomes impractical to continue operation of the cell, and the residual stub or butt of the anode is removed from the cell and replaced by a new anode. The economics of aluminum production favor the crushing and recycle of these butts into fresh anodes. However, there are some problems regarding the recycle of these butts. Because of their low porosity, there is no penetration of pitch into the butt during formation of the anode. This can ultimately cause problems related to anode strength, density, and conductivity. For these reasons, in commercial practice, anodes will rarely contain more than 20 percent of recycled anode butts. Any excess material is typically relegated to lower value uses such as a fuel source.

It has now been found that these anode butts, because of their availability, low sulfur, ash and metals content, hardness and relatively high density, are ideal for blending, usually in a crushed state, with the calcined petroleum coke used as a carbonaceous reductant in the fluidized bed chlorination of titanium-containing materials such as rutile ore. The hardness of the crushed anode butts gives them a resistance to attrition in the fluidized bed so they tend not to break into smaller particles that are elutriated from the chlorination reactor, while the low ash, metals and sulfur content keep them from adding impurities into the chlorination process. Moreover, since the anodes have been baked and are exposed to high temperatures in the aluminum production process, they do not need calcining before they are used in the chlorination process.

The particulate anode butts used in the process of the invention have a Hardgrove Grindability Index between about 20 and 45, usually between about 25 and 40. Because of their relative hardness, they tend to be more attrition resistant than calcined sponge coke and therefore are retained more easily in the chlorination reactor so their carbon can be better utilized as a fuel source and a reductant.

In addition to their hardness, the particulate anode butts tend to have relatively high particle densities, usually between about 2.0 and about 2.3 g/cc³, which tend to keep them from being easily carried out of the fluidized bed by the fluidizing gases. The particles also are low in metals content, typically containing less than about 0.3 weight percent nickel, iron and vanadium, calculated as the metal, and therefore do not contribute any significant contamination by way of these metals in the fluidized bed reaction zone. Other properties of the particulate anode butts include a particle size between about 6 and 40 mesh on the U.S. Sieve Series Scale, i.e., a particle size ranging between about 250 and 5,000 microns.

The one potential disadvantage of using particulate anode butts as the carbonaceous reductant in chlorinating titanium-containing materials is their potential high aluminum content in the form of a coating produced during operation of the aluminum reduction cell. Because of this potential coating, it is generally desirable that a mixture of the particulate anode butts and particulate sponge coke or some other form of petroleum coke, such as fluid coke or shot coke, be used as the carbonaceous reductant. In general, the mixture will comprise up to 50 weight percent particulate anode butts with the remainder being a calcined particulate petroleum coke. Usually the carbonaceous reductant is comprised of about 5 to 20 weight percent particulate anode butts and about 80 to 95 weight percent calcined petroleum coke. It will be understood, however, that if the anode butts produced in the aluminum reduction cells are not highly coated with aluminum, the particulate anode butts produced therefrom can comprise greater than 50 weight percent, and as high as 75 weight percent, of the carbonaceous reductant.

There are four potential ways to form the mixture of particulate anode butts and particulate petroleum coke used as the carbonaceous reductant in the fluidized bed chlorination process of the invention. First, the anode butts can be separately crushed and screened into the desired particle size fraction and then blended with the particulate calcined petroleum coke. Since the calcined coke is prepared by passing green coke sequentially through a rotary kiln at a temperature between about 2000° F. and about 3000° F., a rotary cooler at a temperature between about 200° F. and about 400° F., and a crushing-screening circuit to produce the appropriate size fraction, this method has the disadvantage of requiring a separate and additional crushing-screening circuit to crush and size the butts.

The second method is to blend the anode butts with green petroleum coke prior to feeding the coke to the rotary kiln. The calcined coke-anode butts mixture is then passed through the rotary cooler and processed through a crushing-screening circuit integral with the rotary cooler. The disadvantage of this method is that energy is required to process the butts in the rotary kiln, an unnecessary step because the butts are already essentially calcined.

The third method is to add the butts to the rotary cooler and mix them with the hot calcined coke that is exiting the kiln. The elevated temperatures in the rotary cooler gives the advantage of drying the butts if they contain excess moisture. The cooled product mix is then passed to the crushing-screening circuit that is integral with the rotary cooler.

Finally, the fourth method is to add the butts to the calcined coke product exiting the rotary cooler. The mixture is then processed in the crushing-screening circuit that is fed by the rotary cooler.

The residual anode butts that are removed from the aluminum reduction cells may range in size up to several inches in diameter. Thus, it may be desirable in some cases to pre-crush the butts to reduce their nominal size below about one inch before they are subjected to the crushing and screening described above. This would make the size of the anode butts comparable to that of the calcined petroleum coke and allow them to be more smoothly processed in any of the methods described above.

Once the mixture of particulate anode butts and particulate calcined petroleum coke is formed and is in the desired size fraction, i.e. usually about 60 by 4 mesh on the U.S. Sieve Series Scale, it is ready for use in the process of the invention. In accordance with the process, the mixture is combined with the titanium-containing material to be chlorinated and the resultant mixture is passed into a fluidized bed reactor. Here the particles of the mixture are fluidized with chlorine gas under chlorination conditions, usually a temperature between about 700° C. and 1100° C. When the titanium-containing material is rutile ore, the temperature preferably ranges from about 800° C. to about 1000° C.

Typically, a sufficient amount of the particulate mixture of anode butts and petroleum coke is mixed with the titanium-containing material such that the resultant mixture has a carbon content between about 10 and 50 weight percent, usually between about 10 and 30 weight percent. The titanium-containing material should have a particle size similar to that of the anode butts and calcined petroleum coke so that uniformity is obtained in the fluidized bed in the chlorination reactor.

In the fluidized bed reaction zone, chlorine reacts with titanium dioxide in the titanium containing feed material in the presence of the carbonaceous reductant to form titanium tetrachloride and carbon dioxide. The titanium tetrachloride is separated from the effluent of the fluidized bed reactor and then reacted with air to produce chlorine and fine particle titanium dioxide. The resultant chlorine is then recycled to the fluidized bed reactor.

Although this invention has been described by reference to several embodiments, it is evident that many alterations, modifications and variations will be apparent to those skilled in the art in light of the foregoing description. Accordingly, it is intended to embrace within the invention all such alternatives, modifications and variations that fall within the spirit and scope of the appended claims.

1. A carbonaceous mixture comprising particles of calcined petroleum coke and particles of anode butts produced by the partial consumption of carbon anodes during the production of aluminum in an electrolytic aluminum reduction cell, wherein said mixture is comprised of particles capable of being fluidized in a fluidized bed reaction zone and is devoid of an agent for binding said particles of petroleum coke with said particles of anode butts.

2. The carbonaceous mixture defined by claim 1 wherein said calcined petroleum coke comprises shot coke.

3. The carbonaceous mixture defined by claim 1 wherein said calcined petroleum coke comprises fluid coke.

4. The carbonaceous mixture defined by claim 1 wherein said calcined petroleum coke comprises sponge coke.

5. The carbonaceous mixture defined by claim 1 comprising between about 1.0 weight percent and about 50 weight percent anode butts and between about 50 weight percent and about 99 weight percent calcined petroleum coke

6. The carbonaceous mixture defined by claim 1 comprising between about 5.0 weight percent and about 20 weight percent anode butts and between about 80 weight percent and about 95 weight percent calcined petroleum coke.

7. A carbonaceous mixture capable of being fluidized in a fluidized bed reaction zone, said mixture consisting essentially of particles of calcined petroleum coke and particles of anode butts produced by the partial consumption of carbon anodes during the production of aluminum in an electrolytic aluminum reduction cell.

8. A fluidized bed process for chlorinating a particulate titanium-containing material to produce titanium chloride which process comprises contacting said particulate titanium-containing material with chlorine in the presence of a particulate carbonaceous reductant in a fluidized bed reaction zone under chlorination conditions, wherein said particulate carbonaceous reductant comprises particles of anode butts produced by the partial consumption of carbon anodes during the production of aluminum in an electrolytic aluminum reduction cell.

9. The process defined by claim 8 wherein said particulate carbonaceous reductant comprises a mixture of said particles of anode butts and particles of calcined petroleum coke.

10. The process defined by claim 8 wherein substantially all particles of said anode butts have a nominal size between about 250 and about 5,000 microns.

11. The process defined by claim 8 wherein said particulate titanium-containing material comprises rutile ore.

12. The process defined by claim 8 wherein said fluidized bed reaction zone is maintained at a temperature between about 700° C. and about 1100° C.

13. The process defined by claim 8 wherein the particulate solids in said fluidized bed reaction zone comprise between about 10 weight percent and about 30 weight percent carbon.

14. The process defined by claim 9 wherein said particulate carbonaceous reductant comprises between about 1.0 weight percent and about 50 weight percent anode butts and between about 50 weight percent and about 99 weight percent petroleum coke.

15. The process defined by claim 9 wherein said particulate carbonaceous reductant comprises between about 5 weight percent and about 20 weight percent anode butts and between about 80 weight percent and about 95 weight percent petroleum coke.

16. The process defined by claim 9 wherein said particulate carbonaceous reductant is produced by mixing pre-crushed anode butts with calcined petroleum coke exiting a rotary kiln, passing the resultant mixture through a rotary cooler and then crushing and screening the cooled mixture to produce carbonaceous particles having a size that makes them capable of being fluidized in a fluidized bed reaction zone.

17. The process defined by claim 9 wherein said particulate carbonaceous reductant is produced by mixing pre-crushed anode butts with green petroleum coke and passing the resultant mixture sequentially through a rotary kiln, a rotary cooler and a crushing and screening circuit to produce calcined carbonaceous particles having a size that makes them capable of being fluidized in a fluidized bed reaction zone.

18. The carbonaceous mixture of claim 1 made by the process of mixing pre-crushed anode butts with calcined petroleum coke exiting a rotary kiln, passing the resultant mixture through a rotary cooler and then crushing and screening the cooled mixture to produce particles having a size that makes them capable of being fluidized in a fluidized bed reaction zone.

19. The carbonaceous mixture of claim 1 made by the process of mixing pre-crushed anode butts with green petroleum coke and passing the mixture sequentially through a rotary kiln, a rotary cooler and a crushing and screening circuit to produce calcined carbonaceous particles having a size that makes them capable of being fluidized in a fluidized bed reaction zone.

20. The carbonaceous mixture of claim 1 made by the process of mixing pre-crushed anode butts with calcined petroleum coke exiting a rotary cooler and then crushing and screening the resultant mixture to produce carbonaceous particles having a size that makes them capable of being fluidized in a fluidized bed reaction zone.
